(19) United States
(12) Patent Application Publication
(10) Pub. No.: US 2020/0060242 A1
(43) Pub. Date: Feb. 27, 2020

(54) OYSTER FARMING APPARATUS, METHODS AND SYSTEMS

(71) Applicant: Norman BOYLE, Merimbula (AU)

(72) Inventor: Norman BOYLE, Merimbula (AU)

(21) Appl. No.: 16/610,457

(22) PCT Filed: May 3, 2018
(86) PCT No.: PCT/AU2018/050403

§ 371 Date: Nov. 1, 2019

(30) Foreign Application Priority Data
May 3, 2017 (AU) 2017901617

(51) Int. Cl. A01K 61/65; A01K 61/55

(52) U.S. Cl. CPC A01K 61/65; B63B 35/00; A01K 61/55

(57) ABSTRACT

An apparatus for farming oysters and, in particular, intertidal oysters. The apparatus includes a float, at least one oyster container configured to hold oysters and be carryable on the float, and a driver operable to periodically move each of the at least one oyster container between an underwater position and an above water position.

### TECHNICAL FIELD

The present invention relates to improvements in oyster farming practices. In particular, the present invention relates to improvements in the farming of intertidal oysters.

### BACKGROUND ART

Oysters are in high demand for their taste and nutritional qualities. Oysters are high in protein, contain a range of minerals and other nutrients (including iron, copper, zinc, iodine, magnesium, calcium, manganese, selenium and phosphorus) and are low in fats and carbohydrates. The demand for oysters continues to grow, both within Australia and around the world.

Oyster farming, however, is still somewhat of a cottage industry. While Australia has some of the best conditions for oyster farming in the world, the current industry is dominated by hundreds of small farms. Many of these farms have been in production for decades, using age-old processes and equipment that produces a good product but only on a small scale. In order to meet the growing worldwide demand for oysters, however, such processes may no longer be appropriate.

A further complication arises when farming species of oysters that would usually reside in intertidal areas. Such oysters need to spend some time out of the water and cannot remain immersed (e.g. in underwater cages) for long periods of time. For example, whilst Sydney Rock oysters can survive reasonable periods of time (up to a few weeks) both underwater and above water, they cannot survive in such conditions indefinitely. Presently, farming intertidal oysters such as Sydney Rock oysters therefore involves an oyster farmer having to manually move cages containing such oysters into and out of the water. Typically, this is achieved by positioning two semi-submerged oyster-containing cages on either side of a longline, and then flipping one of the cages about the longline and positioning it on top of the other cage (and hence out of the water). The farmer then periodically flips the upper cage back into the water, and then flips the other cage on top of it in order for the oysters contained therein to spend their period of time out of the water. As would be appreciated, this is a time consuming and physically demanding activity.

It would be advantageous to improve the processes used to farm intertidal oysters such that their production may be scaled up to meet the growing worldwide demand for oysters.

### SUMMARY OF INVENTION

In a first aspect, the present invention provides an apparatus for farming oysters. The apparatus comprises a float, at least one oyster container (e.g. an oyster cage) configured to hold oysters and be carryable on the float, and a driver operable to periodically move each of the at least one oyster container between an underwater position and an above water position.

Advantageously, the apparatus for farming oysters of the present invention reduces the amount of manual labour required when farming intertidal oysters, with a number of attendant benefits to the health and safety of the oyster farmer. Not only is the physical movement of the oysters automatically performed, thereby ensuring that the oysters are constantly worked (e.g. regardless of the day of the week or weather conditions) but, as will be described below, the inventor expects that an optimal growth rate of the oysters may be achieved by optimising the periods of time the oysters spend above and below the water. Such an automated working of the oysters contained in the apparatus of the present invention can significantly increase the efficiency of an oyster farm, when compared with existing practices.

Typically, a plurality of oyster containers are carryable on the float, in order to increase the number of oysters which can be carried by each apparatus, and thus even further increase the farm's efficiency. In some embodiments, and as will be described in further detail below, the weight of the oyster cages may also be used to offset one another, which may help to reduce the energy required to drive movement of the oyster cages.

In some embodiments, a plurality of oyster containers may be provided in a rotatable cylinder. In such embodiments, each of the oyster containers may, for example, be radially positioned in the rotatable cylinder. In such embodiments, the driver may be operable to rotate the rotatable cylinder (e.g. the driver may be operably coupled to an axis of the rotatable cylinder). As would be appreciated, rotation of such a cylinder may be achieved using a relatively low amount of power due, at least in part, to the arrangement of the oyster cages about the axis.

In some embodiments, the driver may be actuated by a remote motor. In such embodiments, the driver may comprise a driven member (e.g. a driven pulley) that is rotatable upon actuation of the remote motor. The remote motor may, for example, drive an endless rope and the driven member comprise an endless rope receiving channel. The endless rope may, in some embodiments, comprise spaced knots, the spaced knots being receivable within complementary recesses in the endless rope receiving channel.

In some embodiments, the driver may be operable to move each of the at least one oyster container between the underwater and above water positions at a rate that mimics an intertidal environment. Alternatively, the driver may be operable to move each of the at least one oyster container between the underwater and above water positions on a daily basis. As noted above, the inventor expects that an optimal oyster growth rate may be achievable by adjusting the lengths of time the oysters spend above and below the water.

In some embodiments, the at least one oyster cage may be detachable from the float. In some embodiments, for example, the at least one oyster cage may be liftable on and off the float. In this manner, the oyster holding portion of the apparatus can itself be removed, for example in order to transport the oysters to a grading facility (as will be described below) or to market.

In some embodiments, the float may comprise opposing side walls having channels which are configured to receive complementary portions of the at least one oyster container therein. In such embodiments, the channels may be tapered such that the at least one oyster cage is guided into position whilst being lowered onto the float. As would be appreciated, such tapering may help to simplify the removal and (more particularly) the return of the cage(s) to the float, which might otherwise be complicated by factors such as wind or choppy water.

In some embodiments, each of the oyster containers may comprise a lid that is openable in order to access an interior of the oyster container (and hence any oysters contained therein). In some embodiments, each of the oyster containers (or at least one of the oyster containers) may comprise one or more partitions that define separate oyster containing portions of the container. Such partitions can help to prevent bunching up of the oysters, which might restrict their access to nutrients in the water and thus hinder their rate of growth.

In a second aspect, the present invention provides a system for farming oysters. The system comprises a plurality of apparatus for farming oysters, a longline on which each of the plurality of apparatus for farming oysters is arranged, and a parent float arranged on the longline and comprising a motor operable to actuate the drivers of each of the plurality of apparatus for farming oysters. Each apparatus comprises a float, at least one oyster container configured to hold oysters and be carryable on the float, and a driver operable to periodically move each of the at least one oyster container between an underwater position and an above water position.

In some embodiments, the system may further comprise an endless rope which is driveable by the motor in order to actuate the drivers of each of the plurality of apparatus for farming oysters.

In some embodiments, the system may comprise one parent float for each ten apparatus for farming oysters. In such embodiments, the parent float may be arranged on the longline at one side of the ten apparatus for farming oysters.

In some embodiments of the system of the second aspect of the present invention, the plurality of apparatus for farming oysters may be the apparatus for farming oysters of the first aspect of the present invention, as described herein.

In a third aspect, the present invention provides a floating vessel for deploying and retrieving the at least one oyster container being carried on the float of the apparatus for farming oysters of the first aspect of the present invention or on the float of the system of the second aspect of the present invention. The floating vessel comprises spaced hulls configured to span the apparatus, a deck and a centrally located portal, through which the at least one oyster container being carried on the float is accessible from the deck.

In some embodiments, the floating vessel may further comprise a lifter operable to lift the oyster container(s) off the float and on to the vessel. In some embodiments, the floating vessel may further comprise a gantry operable to manoeuvre the oyster containers above the deck. In some embodiments, the vessel may further comprise racks upon which the collected oyster containers are locatable.

In some embodiments, the floating vessel may comprise a first portion for housing recently collected oyster containers (e.g. which contain oysters that require grading or which are ready for market) and a second portion for housing oyster containers ready for deployment (i.e. containing recently graded oysters).

The system of the second aspect of the present invention may also further comprise the floating vessel of the third aspect of the present invention.

In a fourth aspect, the present invention provides a carousel for use with the apparatus for farming oysters of the first aspect of the present invention, the carousel comprising an axis about which a plurality of oyster containers are radially arranged. The inventor has found that numerous advantages of efficiency and construction can be attained with such a configuration, as will be described in further detail below.

In some embodiments, the plurality of oyster containers may be radially arranged whereby their weight is substantially evenly distributed about the axis. In some embodiments, an end of the axis comprises a member that is coupleable to the driver such that operation of the driver causes the carousel to rotate about the axis.

In one form of commercial operation of an oyster farm utilising the teachings of the present invention, it is envisaged that oysters held in a particular container (e.g. oyster cage), carousel or even longline, may be owned by individual investors. For example, juvenile oysters can be purchased for a relatively low price by an investor, who subsequently pays a fee to house the oysters in accordance with the present invention until such time as they are ready for market.

Other aspects, features and advantages of the present invention will become apparent in the description of the invention that follows.

### BRIEF DESCRIPTION OF THE DRAWINGS

Embodiments of the present invention will be described in further detail below with reference to the accompanying drawings, in which:

FIG. 1 shows a perspective view of an apparatus for farming oysters in accordance with an embodiment of the present invention, deployed on a longline;

FIG. 2A shows a perspective view of a system for farming oysters in accordance with an embodiment of the present invention, including a plurality of the apparatus for farming oysters of FIG. 1 deployed in-line along a longline;

FIG. 2B shows a side view of a longline, along which three banks of ten of the apparatus for farming oysters of FIG. 1 and their corresponding parent floats are arranged;

FIG. 3A shows a carousel for use with an apparatus for farming oysters in accordance with an embodiment of the present invention;

FIG. 3B shows the carousel of FIG. 3A, in which the lid of one of its oyster cages is in an open configuration;

FIG. 4 shows an exploded view of the apparatus of FIG. 1 on a longline;

FIG. 5 shows a perspective view of the opposite side of the apparatus of FIG. 1 on a longline;

FIG. 6 shows a cross-sectional view of the apparatus of FIG. 1, through the driver side of the apparatus at the section marked 6 in FIG. 5;

FIG. 7 shows a cross-sectional view of the apparatus of FIG. 1, through the driver side of the apparatus at the section marked 27 in FIG. 5;

FIG. 8A shows a perspective view of a parent float for driving movement of the oyster cage(s) of apparatus(es) for farming oysters in accordance with an embodiment of the present invention;

FIG. 8B shows a cross sectional view of the parent float of FIG. 8A, taken along a mid-point of the float at the section marked 8B in FIG. 8A;

FIG. 9 shows an end view of a floating vessel for retrieving and deploying carousels of the apparatus of FIG. 1;

FIG. 10 shows a side perspective view of the floating vessel of FIG. 9; and

FIG. 11 shows an upper perspective view of the floating vessel of FIG. 9.

### DESCRIPTION OF EMBODIMENTS

As described above, the present invention relates to improved oyster farming apparatus, methods and systems. The invention has particular applicability for farming intertidal oysters such as Sydney Rock oysters, but could be used to farm any kinds of oysters which are capable of surviving periods of time above the water.

The present invention will be described below in the context of farming Sydney Rock oysters. The teachings contained herein would, however, be adaptable by a person skilled in the art for farming other intertidal oysters and indeed, under some circumstances, even subtidal oysters (i.e. those which can survive periods of time above water).

Modern oyster farming involves a number of stages. Briefly, oyster spats are typically grown in a nursery until they reach a size of about 3.1 mm, after which time they are ready to be transferred to an estuarine environment. The oyster spats are held in juvenile oyster cages until they reach a size of about 15 mm, with grading (using a ‘wet grader’ system so as not to damage the oyster shell) being carried out approximately every 6 weeks to ensure appropriate growth. The juvenile oysters are then transferred to grow-out cages, where they grow from about 15 mm to a marketable size of about 90-100 mm. It takes between 3-3½ years to grow Sydney Rock oysters to a marketable size, and it is during the grow-out stage that the present invention may be utilised. This is the stage where the oyster's growth is most important, and the time, space and labour involved traditionally makes it the most costly part of the oyster growing process.

Intertidal oysters naturally grow on surfaces that experience a range of tidal heights, meaning that they are constantly going in and out of the water as they grow. This constant submerging and emerging from the water promotes their growth. The present invention advantageously mimics this natural occurrence, and may even have the potential to improve the rate of growth of oysters.

The apparatus of the present invention comprises a float, at least one oyster container configured to hold oysters and be carryable on the float, and a driver operable to periodically move each of the at least one oyster container between an underwater position and an above water position.

The system of the present invention comprises a plurality of apparatus for farming oysters, a longline on which each of the plurality of apparatus for farming oysters is arranged or arrangeable, and a parent float arranged or arrangeable on the longline and comprising a motor operable to actuate the drivers of each of the plurality of apparatus for farming oysters. Each apparatus comprises a float, at least one oyster container configured to hold oysters and be carryable on the float, and a driver operable to periodically move each of the at least one oyster container between an underwater position and an above water position.

The apparatus of the present invention includes at least one oyster container which is carried on or carryable by the float. The oyster container(s) may take any form and have any shape suitable for use in the manner described herein. In some embodiments, the oyster container may be provided in the form of an oyster cage, such cages already being commonplace in the industry.

In some embodiments, the container may be a rectangular prism, such a container being convenient to fill with oysters and to empty oysters from. The container(s) could alternatively have a cylindrical or triangular pyramidal shape, for example, if such a shape might provide an advantage (e.g. a more effective weight distribution or larger carrying capacity). In embodiments where the apparatus includes two or more containers, each container may be the same as or different to the other containers.

The containers may be made from any suitable material. The containers should be corrosion resistant and be strong enough to handle extended immersion in water, exposure to ultraviolet radiation, repeated handling (e.g. during oyster grading, as will be described below) as well as the expected wear and tear of constant tidal movements. Typically, the containers would be made from a plastics material, preferably a food grade plastics material in order to reduce any risk of contamination of either the oysters or the estuarine environment in which they are grown. Appropriately durable and corrosion-resistant metals may, however, be used in some circumstances.

The side walls (and often all faces) of the containers also typically have a number of apertures in order to allow water to flow through the containers, such that nutrients in the water are readily available to be consumed by the oysters held therein. The size and pattern of the apertures can be adjusted based on factors such as the size of the oysters to be contained therein and the nutrient content of the water. In general, the larger the apertures the better, although they should (of course) not be so large that younger (and hence smaller) oysters might fall out. Furthermore, allowing such a flow of water through the containers may help to reduce the drag of the containers in the water, which can be important when a large number of containers are on the same longline and repeatedly subjected to tidal flows in opposite directions.

Whilst the apparatus might only include one oyster-containing container, a plurality of the containers would more typically be carried on the float, at least for reasons of efficiency. The relative positioning of the two or more oyster containers (with respect to each other as well as to the other components of the apparatus) can, for example, be adapted in order to evenly distribute the oysters in the water column, for the containers' weights to offset each other so that the float remains substantially level in the water, regardless of the relative positions of the oyster containers and/or so that the oyster containers require less energy to move.

Oysters at different stages of growth can, for example, be held in the different containers in order for each apparatus to provide a relatively continuous supply of marketable oysters.

In some embodiments (described in further detail below), a plurality of oyster containers may be provided in a rotatable cylinder, which is also referred to herein as a carousel. The oyster containers may be positioned in any configuration on the rotatable cylinder, but radially positioning the containers in the rotatable cylinder can more evenly distribute their weight across the cylinder and may therefore be preferred. As will be described below, the oyster containers may, in some embodiments, define spokes of the cylinder, with their weight being substantially evenly distributed about the cylinder's axle.

In such relatively evenly balanced embodiments, the driver (described in more detail below) is operable to rotate the rotatable cylinder with less energy than might otherwise be required if the oyster containers were not so evenly balanced. The driver may, for example, be operably coupled to an axle of the rotatable cylinder, where turning the cylinder's axle causes the oyster containers to move between their underwater and above water positions.

In alternative embodiments, other mechanisms may be used to move the oyster-containing containers between their under- and above-water positions. For example, see-saw, conveyor or endless-loop type mechanisms would all be effective.

The oysters need to be periodically graded in order to ensure that they are growing at an appropriate rate, necessitating their transport to a land-based facility. One method via which the oyster containers can be retrieved is to provide the carousel (or any other form in which the oyster container(s) are provided) with an upper attachment point for lifting off the float and out of the water. The upper attachment point may be located on any upper portion of the carousel (container(s)), provided that it is readily accessible. Typically, the upper attachment point comprises laterally spaced apertures in order for the float to be substantially evenly balanced when lifted (e.g. as described below). The upper attachment points may have any suitable form and may, for example, be an aperture adapted to receive a hook therein.

The oyster containers typically include a lid that is openable in order to access an interior of the container (and hence any oysters contained therein). The container may, for example, include an end that is openable (e.g. by pivoting about an edge) in order to access oysters contained within the container (or to add oysters to an empty cage).

In some embodiments, the oyster containers may comprise one or more partitions that define separate oyster holding portions of the container. By distributing the oysters across a number of smaller containers, the oysters can be more evenly spread out and therefore better able to access nutrients in the water flowing through the cages. As would be appreciated, the growth rate of oysters will increase with their access to nutrients in the water. Oyster containers having a smaller size then conventional oyster cages (which can be extremely large in some cases, although not typically for intertidal oyster farming) may also be easier to handle and empty, etc.

Traditionally, oysters are held in large cages whilst growing. Whilst such cages are fit for purpose (and have been used in the oyster industry in Australia for many years), the inventor has recognised that they have a number of attendant problems, many of which can be overcome using oyster containers in accordance with the present invention. Advantageously, providing oyster-containing containers in the potentially smaller form described herein enables these container to have a significantly smaller volume than conventional oyster cages, but with the assembly of containers having a combined volume capable of holding the same number (or more) of oysters.

The apparatus of the present invention also includes a float which can carry the oyster container(s). The float may have any suitable form and shape, provided that it floats and can carry the oyster holding container(s) in a manner whereby they can move between their above water and underwater positions. In some embodiments, the float may, for example, have a substantially rectangular footprint, such a shape being relatively easy to manufacture, generally stable in the water and capable of bridging the gap between two parallel longlines. In some embodiments the float may comprise rounded edges in order to reduce the risk of the float becoming jammed between the hulls of a floating vessel, as is described below.

The float must float at a level on the surface of the water whereby the oyster holding container(s) carried thereon are capable of moving between their under- and above-water positions. In some embodiments, the buoyancy of the float may be adjusted if necessary (e.g. by adding water or sand, etc. to a chamber in the float) to take account of differing weights of the oysters to be carried.

Ideally, and especially where the oysters are being grown in relatively shallow water, the float may have a configuration that ensures the oyster containers are kept off the sea floor and hence still able to move, even in the event of an extremely low tide. Some prior art farming practices result in the oysters spending some time in the mud on a sea floor during low tides, which provides less than optimal growing conditions.

As noted above, the oyster-containing container(s) need to be periodically collected in order to grade the oysters, and again when the oysters are ready for market. Whilst such collection may involve collecting the entire apparatus, transporting it to the grading facility and then redeploying the apparatus (i.e. with freshly-graded oysters), it may be more efficient if only a minimum of the components of the apparatus needed to be collected. Accordingly, in some embodiments, the at least one oyster container may be detachable from the float (e.g. by lifting directly off the float). Where there is more than one oyster container, each container may be separately detached/lifted off the float, although it may again be more efficient if all of the containers were detached/lifted off the float at the same time (e.g. as is the case for the rotatable cylinder/carousel described herein).

The float may, for example, comprise opposing side walls having channels which are configured to receive therein complementary portions of the oyster container(s) or, in appropriate embodiments, complementary portions of the component (e.g. the carousel described herein) in which the oyster containers are provided. Such channels may be tapered so that the at least one oyster container (etc.) is guided into position whilst being lowered onto the float, which may make this operation simpler to perform, even in windy and choppy water conditions. In embodiments where the oyster containers are provided in the carousel described herein, for example, the channels may be configured to receive the opposing ends of the carousel's axle.

The float may also include attachments for attaching the float to one or more longlines. Whilst the float may be attached to one longline only, it would more typically be attached between two (usually parallel) longlines in order to more securely locate it with respect to any adjacent floats/apparatus. In embodiments where the float spans between two parallel longlines, opposing edges of the float may include longline attachments having any suitable form. In one embodiment, for example, the longline attachments (or at least one of the longline attachments) may be provided in the form of channels in the sides of the float, and into which the longline is receivable. Latches, or the like, may be provided in order to securely retain the longline within the channel. In some embodiments, for example, an entry to the channel may be closable by a latch that is operable (e.g. moveable) by a user. The latch may, for example, be pivotable (or otherwise moveable, e.g., by sliding or twisting) between channel open (i.e. channel unblocked) and channel closed (i.e. channel blocked) configurations. The latch may, for example, comprise a handle that is graspable by a user (e.g. a user wearing gloves).

In some embodiments, the channel may also include a recess which is complementary in shape to a bulbous portion of the longline (e.g. provided in the form of a knot in the longline, as described below). Once the bulbous portion is received in the recess, it should not be possible for the float to slide along the longline. Thus, the float(s) are not able to escape from the longline(s) due to at least one of the longlines being located in and retained by the channel, and the location of the bulbous portion in the recess substantially prevents movement of the (each) float along a length of the longlines.

Advantageously, in this embodiment, the floats can thus hold the longlines apart by a consistent distance, with the floats being positionable relatively close together because they cannot easily twist with respect to the longlines (e.g. compared with prior art systems where floats are commonly attached to a single long line and can become entwined if positioned too closely together). Furthermore, as there tends to be much less relative movement between the floats of the present invention and the longlines (e.g. compared with prior art systems), then wear and tear on the floats (and other components of the oyster farm) due to constant water movement may be reduced.

It is possible to purchase longlines which have knots pre-tied therealong at precise intervals, thereby providing a longline adapted to receive floats of the present invention at predefined distances apart. The distances between knots/floats will depend on factors such as the dimensions of the floats (and any containers carried thereon) and the strength of the water flow perpendicular to the longlines.

The float may be formed of any suitable material. Typically, the float is formed from a buoyant plastic material, which has a high degree of UV resistance. In embodiments where any of the components of the float are metallic, then these would need to be made from corrosion resistant metals, such as marine grade stainless steel, and would usually be integrally formed with the float (e.g. during the moulding process).

The apparatus of the present invention also includes a driver operable to periodically move each of the at least one oyster container between an underwater position and an above water position. The driver may be operated using any mechanism that is capable of use with the present invention and which causes the container(s) to move between their under- and above-water positions.

The driver may be operable to cause the container(s) to move at any suitable rate. The driver may, for example, move the container(s) between its/their underwater and above water positions at a rate that mimics an intertidal environment. Alternatively, the driver may be operable to move the containers between their underwater and above water positions on a daily basis (or in accordance with another fixed time period). As noted above, the inventor expects that an optimal oyster growth rate (e.g. for a particular species of oyster in a particular location) may be achievable by adjusting the lengths of time the oysters spend above and below the water. Faster or slower rates of movement may therefore provide advantages in some circumstances. The inventor also expects that seasonal changes may also be accounted for by altering the rate at which the container(s) are moved between underwater and above water positions.

In some embodiments, the driver may itself include a motor for driving the container(s) between their under- and above-water positions. However, such embodiments may not be particularly efficient, and especially so in the embodiments of the invention described in more detail below involving a plurality of apparatus arranged along a longline. Thus, more typically, the driver of each apparatus may be actuated by a remote motor (the motor will be described in further detail below).

In such embodiments, the driver may comprise a driven member that can be rotated upon actuation of the remote motor. Such a driven member may be driven using any suitable mechanism, including via an endless rope, where the remote motor causes a linear movement of the endless rope, with that movement being used to rotate the (or each) driver's driven member.

The driven member may have any suitable form. Typically, the driven member is a driven pulley. In one form, the driven member/pulley may comprise an endless rope receiving channel, whereby movement of the rope in the channel causes the driven member/pulley to rotate. In some embodiments, the endless rope receiving channel may taper inwardly and/or include rope gripping teeth or ribs, in order to provide the necessary friction between the rope and channel. Alternatively (or in addition), the endless rope may have spaced knots, the spaced knots being receivable within complementary recesses in the endless rope receiving channel.

For reasons of efficiency, a plurality of the apparatus described herein would usually be arranged in-line along the length of a longline, thereby defining part of the system of the present invention. As noted above, the system of the present invention comprises a plurality of the apparatus for farming oysters, a longline on which each of the plurality of apparatus for farming oysters is arranged, and a parent float arranged on the longline and comprising a motor operable to actuate the drivers of each of the plurality of apparatus for farming oysters.

The patent float may take any form compatible with its use in the present invention, as described herein. Typically, the parent float would have a footprint (or at least a width) and float at a depth similar to that of the apparatuses with which it shares the longline. The parent float may also comprise solar panels and batteries for powering the motor, as well as other components such as measuring apparatus for measuring parameters of the water relevant to the oysters' growth (e.g. its temperature, salinity, dissolved organic content, etc.) and transmission apparatus for transmitting this data to a remote location. The parent float may also have cameras for remote viewing of the longline and an alarm that is triggered in the event of tampering or other detected damage (e.g. storm damage).

The motor on the parent float may take any suitable form. In some embodiments, the motor may comprise a drive sprocket and a driven sprocket, the gearing ratio of which is adaptable in order for the motor (having a specific power output) to be able to actuate the drivers such that they drive movement of the container(s) at an appropriate rate. Indeed, in some embodiments, intermediate gearing may be required in order for the driving system to function. Typically, any such gearing would be in the parent float and associated with the motor, but it may instead (or in addition) be part of the driver of each apparatus.

The system typically also comprises a drive belt, endless rope or other corrosion-resistant drive chain, which is driveable by the parent float's motor in order to actuate the drivers of each of the apparatus for farming oysters. In such embodiments, the parent float's driven sprocket may include an endless rope (etc.) receiving channel. Actuation of the motor thus causes the driven sprocket to turn and hence the endless rope to be advanced.

The system may comprise any number of parent floats, depending primarily on the number of apparatus on the longline, the apparent weight of the oysters in each apparatus and the power output of the motor. In some embodiments, for example, the system may comprise one parent float for each 5, 6, 7, 8, 9, 10, 11, 12, 13, 14 or 15 apparatus for farming oysters.

The parent float may be positioned on the longline in any configuration with respect to its attendant apparatuses. In some embodiments, for example, the parent float may be arranged on the longline at one side of its attendant apparatuses. Alternatively, the parent float may be arranged on the longline intermediate (e.g. in the middle of) its attendant apparatuses.

In some embodiments, the system may include an override, where the motor can be disengaged from the endless rope (or the like) and the endless rope manually advanced. This may be useful in embodiments where a specific cage configuration is required for a particular purpose, such as is the case when the carousels described in further detail below are to be removed from the floats. In such embodiments, a winch or the like may be provided for manually advancing the endless rope.

As described above, the present invention also provides a floating vessel (e.g. a working platform, such as that described in further detail below) for deploying and retrieving the oyster container(s) being carried on the floats of the apparatuses or systems of the present invention. The floating vessel comprises spaced hulls configured to span the apparatuses, a deck and a centrally located portal, through which the at least one oyster container being carried on the float is accessible from the deck.

As will become apparent from the discussion below, the floating vessels of the present invention can provide a number of advantages over the vessels traditionally used for oyster farming. Indeed, such vessels are often simple aluminium flat bottomed boats, from which a user has to lean out of to work (which is bad for the user's health and also carries a risk of the user falling out of the vessel). The floating vessels of the present invention can make it much easier to work oysters more regularly and, by doing this, reduce their growth time by many months.

In some embodiments, the floating vessel may also include a lifter operable to lift the oyster container(s) off the float and on to the vessel. The lifter may be any apparatus that is capable of lifting oyster containers, such as the carousel described herein, which may weigh a few hundred kilograms, especially when they are first withdrawn from the water.

In some embodiments, the floating vessel may also include a gantry for manoeuvring the oyster container(s) above the deck (i.e. once lifted off the float), for example to move the container(s) from directly above the portal to a storage location (described below).

In the floating vessel, the portal through which the oyster containers are liftable from and lowerable onto the float (i.e. liftable out of and lowerable into the water) is centrally located on the floating vessel. As such, the lifter does not need to lift a relatively heavy mass from the side of the vessel, as is the case for many currently-used vessels, but can instead lift it from a central position, thus not potentially unbalancing the vessel. Furthermore, it is not necessary for the user to lean over the side of the vessel in order to retrieve the oyster containers from the water.

Indeed, even where existing vessels include some sort of a lifting device such as a crane, the weight that can be lifted may be limited due to the crane having to extend over a side of the vessel and the subsequent acentric lifting action causing a capsizing risk. Furthermore, even when loaded onto a vessel, it is necessary to store the oyster cages in specific locations on the vessel in order to maintain its level. For this reason, some vessels do not store the collected oyster cages for any length of time, but immediately transfer them to a second boat which takes them to shore for further processing. As would be appreciated, whilst the existing vessels can be made to work in oyster farming applications, they are not really compatible with efficient farming practice, and generally requires multiple vessels and/or multiple trips between the oyster farm and the land based processing facility.

In some embodiments, the floating vessel may also include racks upon which the collected oyster containers are locatable (i.e. using the crane and gantry described above).

In some embodiments, the floating vessel may comprise a first portion for housing recently collected oyster containers (i.e. containing oysters ready for grading or for market) and a second portion for housing oyster containers ready for deployment (i.e. containing recently graded oysters). Such a configuration would even further increase the efficiency of the oyster farm, with graded oysters being returned to the water as soon as possible after grading, at the same time as the next batch of oysters for grading are being collected. Thus, the oysters can be worked more efficiently than would ever be possible in more traditional oyster farms.

In some embodiments, a buoyancy of the hull proximal to the first portion and a buoyancy of the hull proximal to the second portion may be independently adjustable in response to a weight distribution over the floating vessel. Such an adjustable buoyancy operates in response to changes of weight distribution over the floating vessel in order to keep the vessel level, despite potentially having a very large off-centre mass. In some embodiments, the buoyancies of the first and second portions may be independently adjustable to maintain an upper surface of the floating vessel in a substantially level configuration. That is, no matter how many more oyster containers/cages are stored on one of the portions than the other (within reason, of course), their buoyancies are independently adjustable in order to level out the vessel. The significant advantages which this can provide an oyster farmer will be described in further detail below.

Any suitable technique may be used to adjust the buoyancy of the first and second portions. In some embodiments, for example, the hull(s) at the first portion may comprise a first reservoir(s) and the hull(s) at the second portion comprise second reservoir(s), the first and second reservoir(s) being adapted to receive and discharge a fluid (e.g. air or water) in response to the weight distribution over the floating vessel. Fore and aft portions of the port and starboard hulls may, for example, be configured to define appropriate reservoirs.

In some embodiments, for example, the floating vessel may further comprise one or more pumps in communication with the first and second reservoirs, the one or more pumps being operable to pump water into and out of the first and second reservoirs (i.e. in response to the weight distribution on the floating vessel). In some embodiments, the first reservoir may have a first pump and the second reservoir have a second pump. The water may be stored on the floating vessel, or simply pumped in from an inlet underneath the vessel (bearing in mind that this will be brackish water and the pump must therefore be adapted to operate in salt water).

Any suitable system may be used to monitor the angle of the upper surface (i.e. the deck) of the floating vessel (and its various portions) and operate the pump or pumps (or the like) such that the upper surface remains substantially level (or has some other desirable configuration). It is envisaged that a number of sensors would be positioned about the various portions of the floating vessel, with data obtained from these sensors being fed into a CPU operating a program that is capable of sending instructions to independently adjust the buoyancy of the portions (e.g. by actuating the one or more pumps).

The floating vessel may be propelled through the water using any suitable propulsion mechanism or system. In some embodiments, the floating vessel may further comprise a plurality of outlets, from which water may be discharged in order to propel the floating platform through the water. Such outlets are commonly referred to in the industry as jet thrusters and, when orientated facing sideways, side thrusters. Providing such thrusters facing in all directions from the working vessel enables the vessel to be moved in any direction, which can be especially useful when manoeuvring the vessel with respect to long lines (and especially when there are factors such as wind, surface chop and tidal flows to contend with as well). Whilst propellers can also be used to propel the working platform, these should generally be avoided (particularly when manoeuvring around an oyster lease) because of the risk of the propeller blade either damaging or becoming snagged in the infrastructure on an oyster lease (e.g. an oyster cage or longline).

As noted above, in one form of commercial operation of an oyster farm utilising the teachings of the present invention, it is envisaged that oysters held in a particular cage, carousel or even longline, may be owned by individual investors. For example, juvenile oysters (e.g. oysters having a size of about 15 mm or about 50 mm) can be purchased for a relatively low price by an investor, who subsequently pays a fee to house the oysters in the components of the present invention (i.e. depending on the number of oysters purchased) until such time as they are ready for market.

In some embodiments, for example, a customer may purchases a “lease allocation”, which gives them exclusive access to stock growing infrastructure that is maintained and managed by the oyster farm. The customer is then allocated the yield of this infrastructure at a predetermined fixed price per oyster, which are shipped to the customer on a monthly basis. By way of example, a Sydney Rock oyster lease allocation may involve purchasing the exclusive use of a carousel (described below) housing juvenile Sydney Rock oysters. Each of these carousels can produce around 1600 Sydney Rock oysters per year. Sydney Rock oysters are ideal to ship fresh as they can survive out of the water for around three weeks at a time.

Specific embodiments of the present invention will now be described with reference to the accompanying drawings.

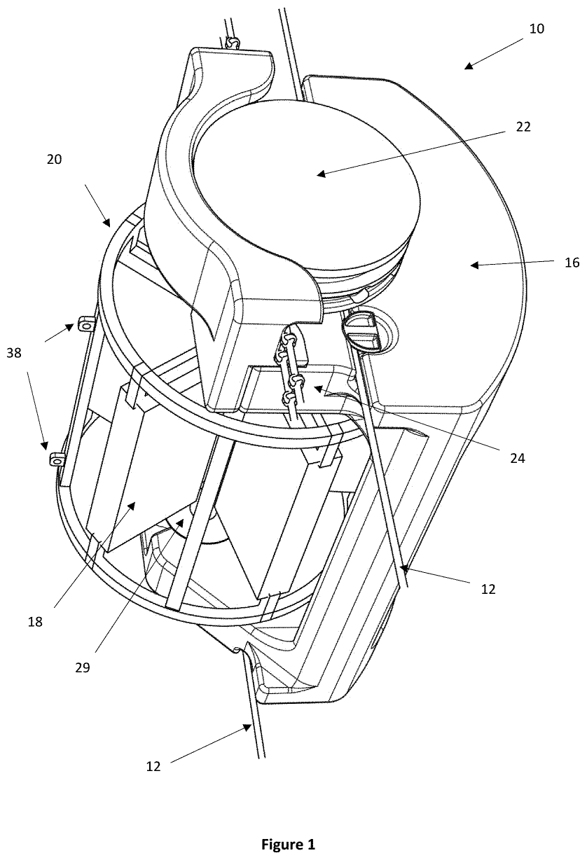

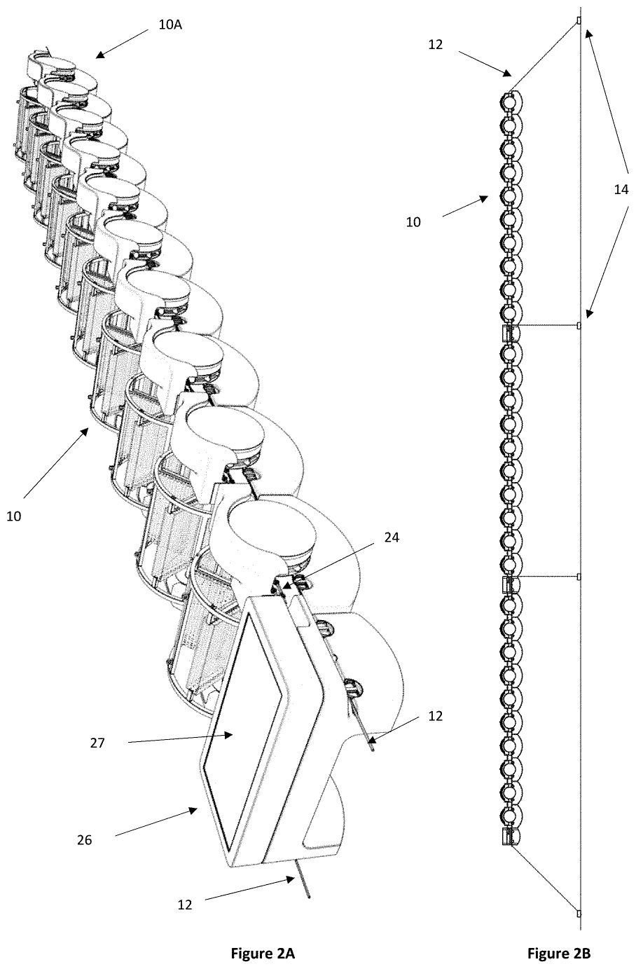

Referring firstly to FIG. 1, shown is an apparatus for farming oysters in the form of apparatus 10. Apparatus 10 is positioned between longlines 12, 12, and held in a fixed location thereon in the manner described below. As can be seen in FIG. 2B, each longline 12 is anchored to the seafloor at anchors 14, with the longlines 12, 12 being maintained in a substantially parallel configuration over their length. The surface of the water is not shown for reasons of clarity, but the longlines 12, 12 are located at about the level of the water's surface. Portions of the apparatus 10 lower than the longlines 12, 12 would thus be underwater.

Apparatus 10 includes a float 16 and oyster holding cages, shown generally as 18, which are carried on a rotatable cylinder shown in the form of carousel 20. Apparatus 10 also includes a driver operable to rotate the carousel 20 (and hence move each cage 18 between an underwater position and an above water position, as will be described below) and shown in the form of driven pulley 22. As will be described in further detail below, driven pulley 22 receives knotted ropes 24 therein in a manner whereby movement of the knotted ropes 24 with respect to the driven pulley 22 causes the carousel 20 to rotate.

Referring now to FIGS. 2A and 2B, shown is a system in accordance with an embodiment of the present invention. The system shown in FIG. 2A includes ten apparatus 10 and a parent float in the form of drive float 26, all of which are attached to the longlines 12, 12 at spaced intervals in the manner described below. An uppermost surface 27 of drive float 26 may include solar panels (not shown) which can generate electricity to power its motor (described below) or to recharge a battery (not shown) which powers the motor. The system shown in FIG. 2B includes three banks of the apparatus 10 and drive float 26 of FIG. 2A, and with the longlines 12, 12 (only one longline can be seen) anchored to the sea floor by a number of spaced anchors 14. The knotted ropes 24 (see FIG. 2A and described in further detail below) extend in a continuous loop from drive float 26 to the apparatus 10A furthest away from the drive float 26.

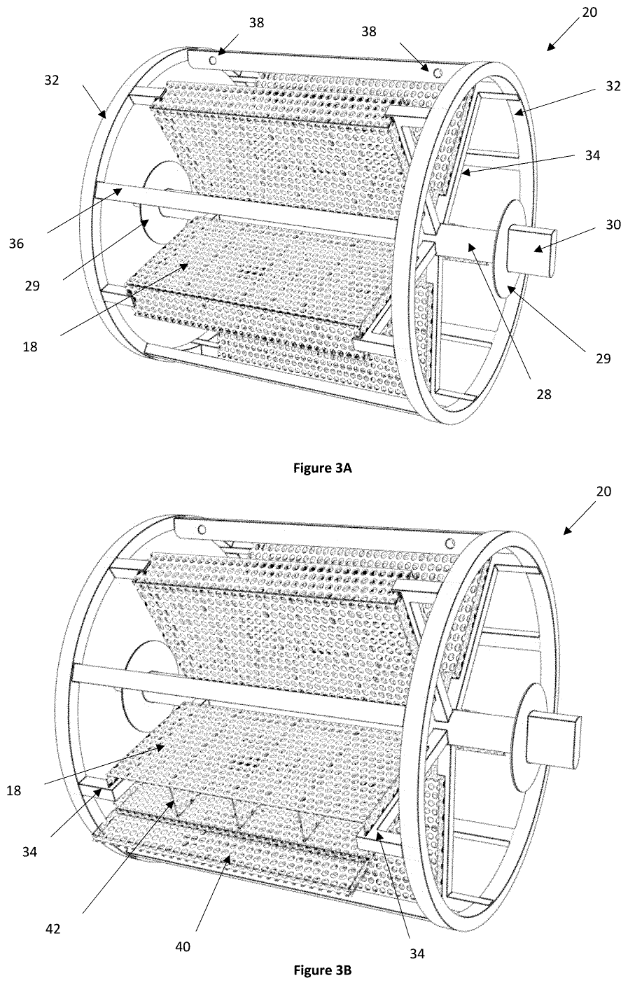

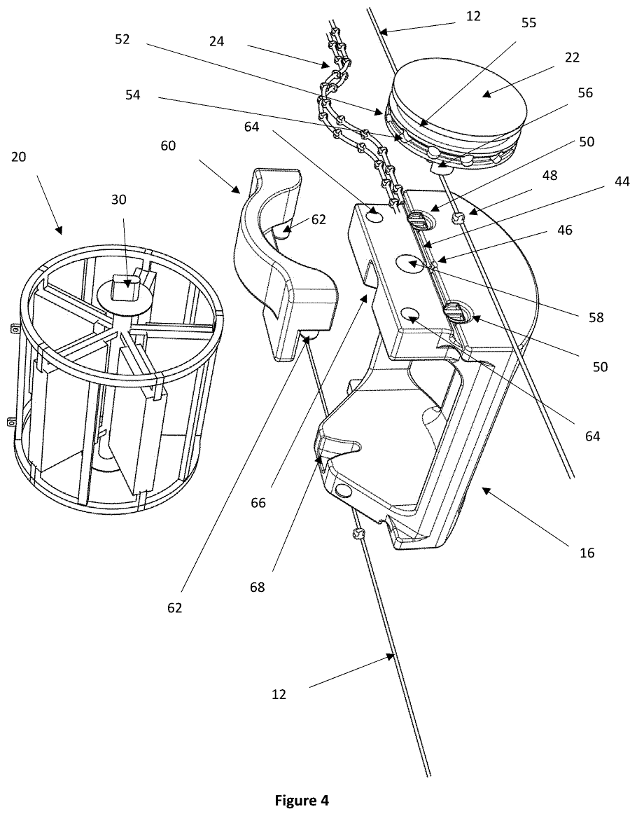

Referring now to FIGS. 3A and 3B, the carousel 20 is shown in greater detail and separate from the other components of apparatus 10. Carousel 20 has an axle 28, about which it can rotate on the float 16 (as described below). Opposing ends of the axle 28 include annular rims 29, 29 (one annular rim 29 can also be seen in FIG. 1), which can be used to appropriately locate the carousel 20 with respect to the float 16 in the manner described below. One of the ends of the axle 28 includes a drive tab 30, which cooperates with the driven pulley 22 in the manner described below in order to rotate the carousel 20. The other end of the axle (not shown) is circular in cross section, which facilitates rotation of the carousel 20 within the float 16.

The carousel 20 has circularly-shaped rims 32, 32 at either end thereof, each rim 32 being supported by and joined to the axle 28 via five spokes, shown generally as 34. The rims 32, 32 of the carousel 20 are also stabilised by a number of cross bars, shown generally as cross bars 36, intermediate the spokes 34. An uppermost cross bar 36 (when the carousel 20 is in its loading/unloading position, as will be described below) has spaced apertures 38, 38 for receiving a fastener thereat in order to lift the carousel 20 out of the float 16 (as will be described below). Apertures 38 are shown inside of cross bar 36 in FIGS. 3A and 3B, but could also be provided in tabs which upwardly project from the cross bar (as shown in FIG. 1, for example).

Carousel 20 includes five oyster holding cages 18, each of which is positioned between respective spokes 34, 34. The cages 18 may be permanently fixed to the spokes 34, 34, or may be releasable therefrom (e.g. by sliding), depending on the preference for loading or unloading of oysters into/from the cages 18. In the embodiment shown, the cages 18 are permanently fixed to the spokes 34, 34. The cages 18 include a lid 40, which is pivotable between an open position (i.e. as shown in FIG. 3B) and a closed position (i.e. as shown in FIG. 3A). When in the open position and in the configuration of the carousel 20 shown in FIG. 3B, any oysters within the cage 18 would fall out and into an appropriately positioned oyster collection facility, which transfers the oysters to a grading facility, for example. Freshly-graded oysters (i.e. ready for deployment back into the water) can easily be delivered into the emptied cage 18 by rotating the carousel 20 such that the cage 18 is upwardly facing with its lid 40 open and pouring an appropriate amount of the oysters into the cage. Once the lid 40 has been closed, then the oysters are securely held therein. Suitable latching means (not shown) would be provided to ensure that the lid 40 cannot be accidentally opened during rotation whilst in the water.

Cages 18 also include a number of partitions, shown generally as 42, which divide the cage up into smaller portions. These partitions 42 prevent all of the oysters contained within the cage 18 from bunching up, which may restrict their access to nutrients in the water column.

It is envisaged that the cages 18 will be formed from sufficiently durable food grade plastics, although they could also be formed from other plastics or corrosion-resistant metals. Each cage 18 is adapted to receive an amount of oysters appropriate to the size of the cage, but not so many that overcrowding may occur, which might potentially hinder growth of the oysters by restricting their access to nutrients in the water. For example, in a specific embodiment of the invention where Sydney Rock oysters are being grown, the cage may be 150 mm wide, 400 mm high and 800 mm long. Carousel 20, having five cages 18 with such dimensions would be expected to be efficiently operated to produce around 1600 Sydney Rock oysters per year.

The apertures in the cage 18 must be of a size that allows water to flow freely through the cage, but not so large that oysters might fall out of the cage. The smallest sized oysters likely to be useable in the apparatus 10 would be juvenile oysters having a size of about 15 mm. Thus the apertures of some cages 18 must be less than 15 mm in order to contain such oysters. If the cages are only to be used to house larger oysters (e.g. 50 mm or larger), however, a larger aperture size would be preferable. In general, as large an aperture size as possible would be preferred, as this enables (nutrient rich) water to flow through the cages 18 with less hindrance. In some embodiments, a carousel 20 may include cages 18 having a variety of aperture sizes. Indeed, in some farming operations, it may be desirable for the carousel 20 to house oysters of different sizes, such that oysters from one of the cages 18 are ready to be harvested each time the carousel 20 is collected (e.g. every 4-6 weeks, as described below), with the oysters in the other cages 18 etc. being graded, returned to their cage and back to the apparatus 10. The empty cage 18 can be filled with new juvenile oysters.

The number of oysters each cage 18 can hold will vary depending on the size of the oyster, although care should be taken not to overcrowd the cages as this may result in sub-optimal growth rates. In one kind of farming operation, for example, the same oysters may remain in the same cage until they are ready for market. In such cases, as about 200 fully-mature Sydney Rock oysters would fit into cages having the dimensions described above, the same number of juvenile oysters (having a size of about 50 mm, for example) may be added to the cage initially, with additional oysters being added at that time to take into account the likely stock loss during the grow out period. For example, about 220 Sydney Rock oysters having a size of about 50 mm could be added to cage 18 initially, hopefully resulting in 200 or more fully mature oysters after about 5 grading cycles. In another kind of farming operation, for example, juvenile oysters having a size of 15 mm may be reared in the cages, either until they reach 50 mm and are transferred elsewhere, or until they reach market size. Regular grading of such oysters would eliminate dead and underperforming oysters, thus providing the best possible growing conditions for the remaining oysters.

As will be appreciated, when used in the oyster farming methods disclosed herein, the size of the cages 18 and carousel 20 will also need to conform to the operational parameters (primarily dimensions and weight) of the relevant working platform.

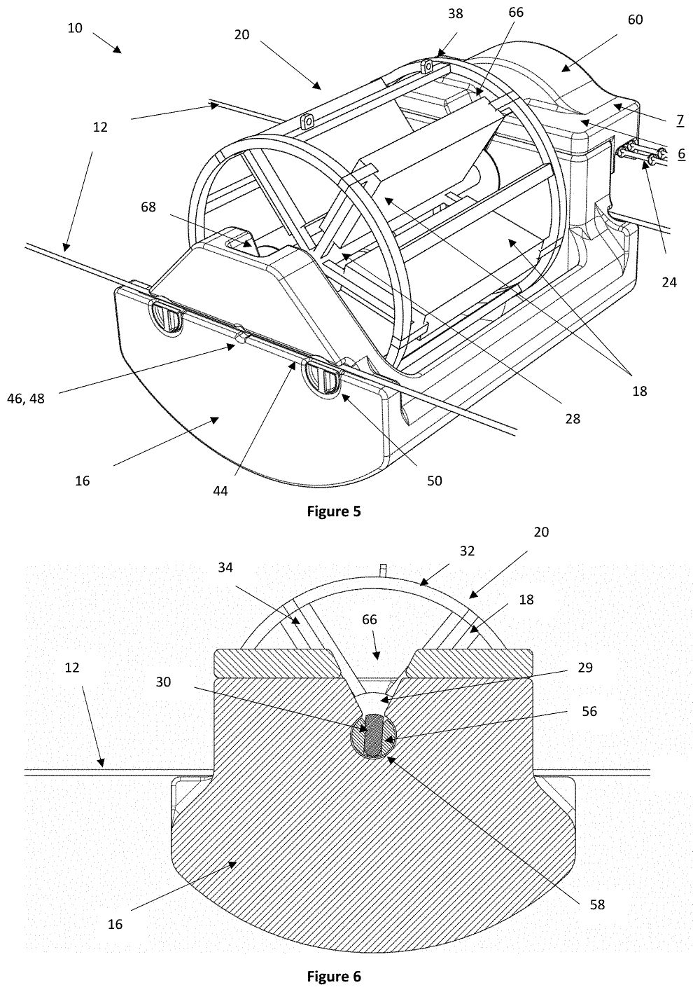

Referring now to FIGS. 4 to 7, it can be seen that the outermost sides of the float 16 include lateral channels 44, 44 for receiving the longlines 12, 12 therein. As channels 44 are identical in the embodiment shown, only one channel will be described herein in detail. Channel 44 extends for the length of the float 16 and includes a centrally located recess 46, which is shaped to receive therein a bulbous portion on the long line 12 (provided, in his embodiment, in the form of a knot 48). The recess 46 may have any shape, provided that it can securely receive and retain the knot 48 therein. Once the knot 48 is received within recess 46 (and long line 12 within channel 44), the float 16 has only a very limited possibility for lateral and longitudinal movement with respect to the long line 12. Latches 50, 50 may be provided in order to securely retain the longline 12 within the channel 44.

A plurality of knots 48 (not shown) are provided at spaced apart intervals on one or both of the longlines 12, 12 in order for each float 16 (and hence each apparatus 10) to be held in specific and predefined locations on the longlines 12, 12 (i.e. as is shown in FIGS. 2A and 2B, where the apparatuses 10 are arranged in line along the longline such that they are very close to, but not touching, each other). In this manner, the apparatus 10 can be held in a very precise configuration on the longlines 12, 12 which can help to maintain the oyster cages 18 in an optimal orientation and make the retrieval and replacement of the carousels 20 run more efficiently.

Referring back to FIG. 4, driven pulley 22 includes an annular channel 52 around its periphery, into which the knotted rope 24 may be received. The channel 52 includes spaced recesses, shown generally as 54, into which the knots of the knotted rope 24 can be received and retained. Longitudinal movement of the knotted rope 24 thereby causes rotation of the driven pulley 22 and hence rotation of the carousel 20 (as described below). A second annular channel 55 is provided next to channel 52, but channel 55 has no recesses and is simply present as a guide for the non-drive side of knotted rope 24, in order to keep it out of the water and contained so that it does not present a snag risk during farming operations.

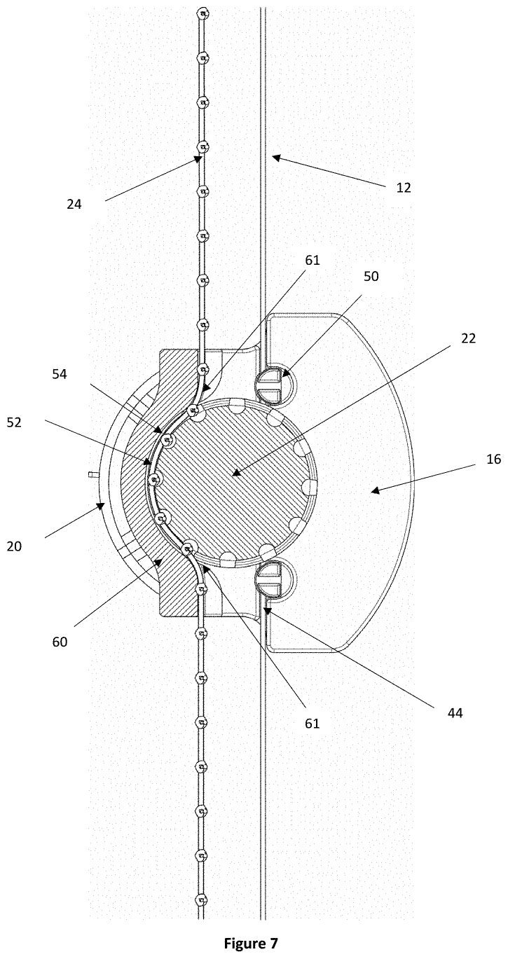

Driven pulley 22 also includes a drive shaft 56 (see also FIG. 6), which is rotatably receivable within aperture 58 on the side of the float 16. Once the drive shaft 56 is within the aperture 58, the driven pulley 22 is in its operating position within the apparatus 10 and, after the knots of the knotted rope 24 are positioned in the channel 52/recesses 54, it is necessary for the driven member 22 to be locked in place. In this regard, a hood 60 is provided having a shape that is complementary to the driven member 22 and which, when appropriately positioned (see FIG. 7) defines a guide channel 61 between the hood 60 and the driven pulley 22 such that the knotted rope 24 is securely retained within the channel 52/recesses 54 and the second channel 55. As can be seen in FIG. 4, hood 60 includes protrusions 62, 62, which are configured to tightly fit in apertures 64, 64 provided on the side of float 16. Once so positioned, hood 60 is securely held in place on the float 16 (e.g. using a plastic latch, or the like, not shown, or due to a frictional fit between protrusions 62 and apertures 64) and it is not possible for the driven pulley 22 or knotted rope 24 to become disengaged from the apparatus 10.

Float 16 also has slots 66, 68 in the inside of its side walls, which are configured to receive the opposite ends of the carousel's axle 28 therein. Slots 66 and 68 are wide at their mouth and then narrow down towards their end, where the axle 28 resides when in its in use configuration. Slot 68 has a substantially circularly-shaped lowermost portion, in which the respective end of axle 28 of the carousal 20 can reside and rotate. Slot 66 has a similar tapering shape but, as can be seen in FIG. 6, has a bulbous lowermost portion that is aligned with aperture 58 and thus configured to receive drive shaft 56 of driven pulley 22 therein. As can also be seen in FIG. 6, driveshaft 56 is shaped to receive the drive tab 30 of the carousel 20 therein. Hence, when in the loading configuration (i.e. that shown in FIGS. 4 and 6), lowering the carousel 20 into the float 16 causes the drive tab 30 to move to the bottom of slot 66, whereupon it operably engages with the drive shaft 56 (i.e. as shown in FIG. 6). Once the carousel 20 rotates out of the position shown in FIG. 6, it cannot escape from the float 16. It may, however, be desirable to include some sort of retaining mechanism (not shown) whereby, once so loaded, the carousel 20 is not able to inadvertently lift out of its operating position as it rotates past the orientation shown in FIG. 6.

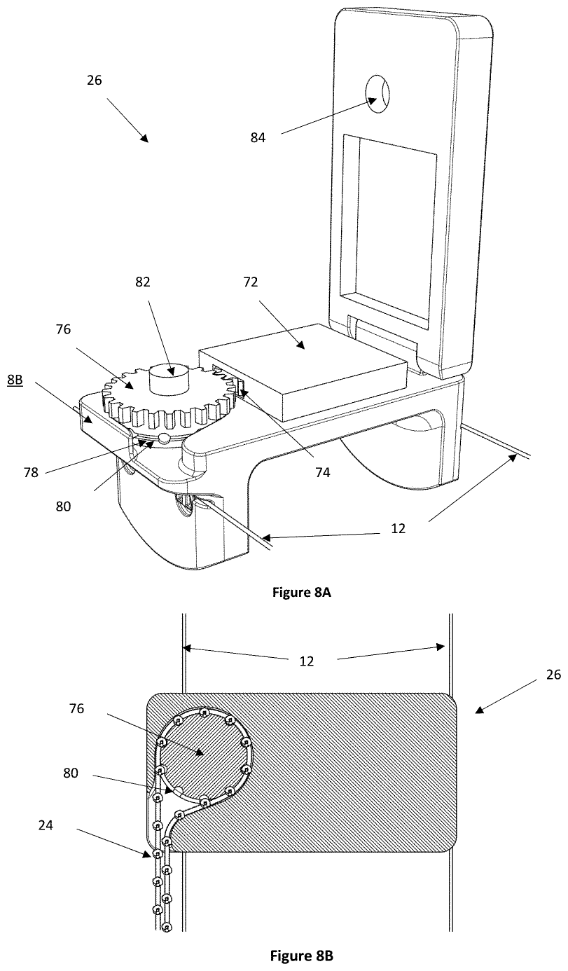

Referring now to FIGS. 8A and 8B, the drive float 26 is shown in greater detail. Drive float 26 has a motor 72, which is operable to drive a drive sprocket 74. Drive sprocket 74 drives a (larger) driven sprocket 76, which includes an annular channel 78 around its periphery, and into which the knotted rope 24 may be received. The channel 78 includes spaced recesses, shown generally as 80, into which the knots of the knotted rope 24 can be received and retained. In this manner, operation of the motor 72 causes a linear progression of the knotted rope 24 around the sprocket 76 and hence through the driven pulley 22 of each apparatus 10 in the system. As described above, additional gearing (not shown) may be provided if an additional mechanical advantage is required to rotate the carousels 20 in the system.

FIG. 8B shows the progression of the knotted rope 24 through the channel defined between the driven sprocket 76 and body of the drive float 26. Driven sprocket 76 has an axle 82 that is received within recess 84 in the lid of the drive float 26.

In use, a linear progression of the knotted rope 24 through the driven pulley 22 of each apparatus 10 in the system causes the drive shaft 56, and hence the carousel 20 (i.e. via the coupling between drive tab 30 and drive shaft 56) to rotate. Rotation of carousel 20 causes the cages 18 to progressively move (i.e. rotate) around the axle 28, which is located just above the level of the water upon which the float 16 is floating. Thus, once a cage 18 is in a position below the axle 28, it would be located underwater. Similarly, once a cage 18 is in a position above the axle 28, it would be located above the water. In this manner, rotation of the carousel 20 periodically moves each of the cages 18 between an underwater position and an above water position, providing appropriate growing conditions for intertidal oysters such as the Sydney Rock oyster.

The rate at which the carousel 20 is rotated can be temporarily varied by adjusting the speed of the motor 72, or more permanently varied by altering the relative sizes of the drive/driven sprockets and/or the size of the driven pulley 22. In some embodiments, the size of the driven pulley 22 may vary between apparatus 10 on the longline, making some carousels rotate faster or slower than others.

It may be desirable in some circumstances to provide a manual override in order for the oyster farmer to disengage the motor 72 in order to manually orientate the carousels 20 (e.g. if the carousels are not in an orientation where they can be lifted out of the floats 16 when the farmer is ready to do this). An appropriate switch (not shown) may be provided to disengage the motor 72, with a winch or the like (again, not shown) being used to winch the driven sprocket 76 (for example) in either direction. An appropriate coupling (e.g. a spindle, similar to that of sailing winches) for receiving the drive shaft of a winch might, for example, be provided in axle 82 and may be accessible without having to open the lid of parent float 26.

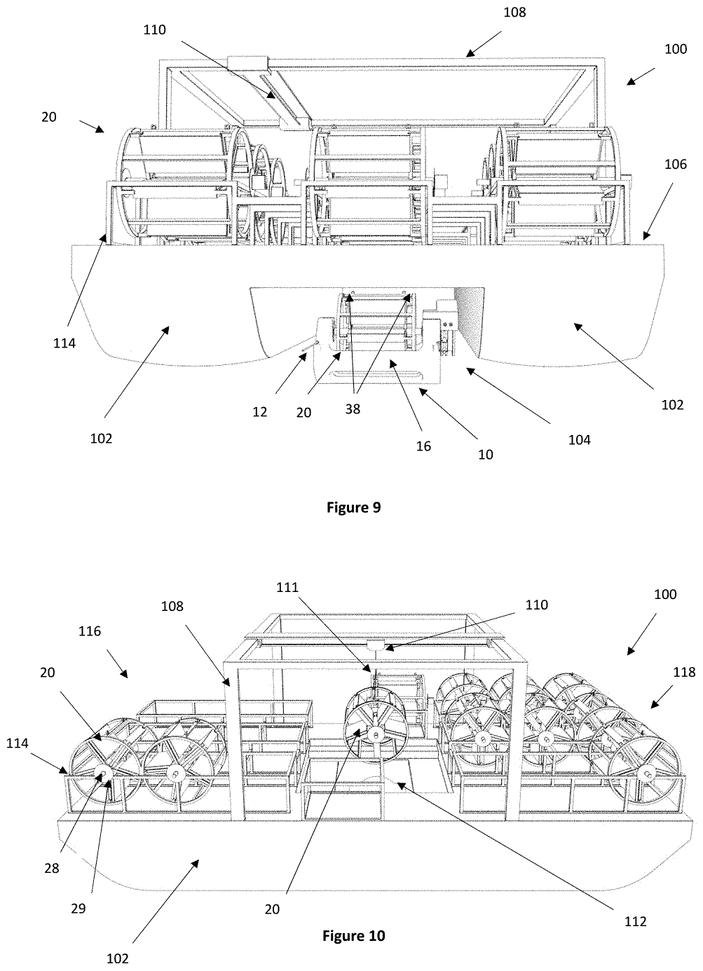

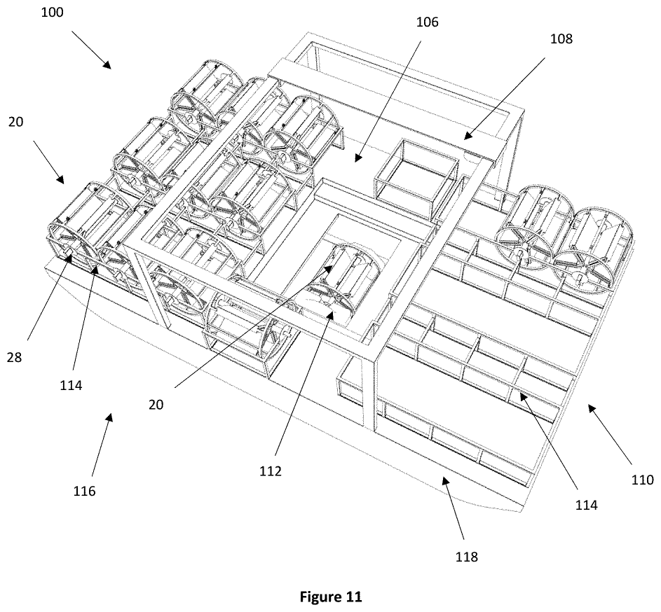

A floating vessel for deploying and retrieving oyster cages in the form of carousels 20 from a long line 12, 12 in accordance with an embodiment of the present invention is shown in FIGS. 9 to 11. Referring firstly to FIG. 9, a floating vessel in the form of working platform 100 is shown. Working platform 100 has two hulls 102, 102, which define a space 104 therebetween that is sized to be able to receive apparatus 10 therethrough. Working platform 100 has a deck 106 and a lifter in the form of a gantry 108 and host 110, which uses a cable 111 (see FIG. 10) to lift, lower and transfer carousels 20 (e.g. via a hook or the like, not shown). A central portion of the deck 106 has a deployment and retrieval portal, shown in the form of portal 112 (see FIG. 10), via which a carousel 20 can be lowered onto or lifted off a float 16 positioned within the space 104 between hulls 102, 102.

Working platform 100 also has a number of storage rails 114 spread over the deck 106. Storage rails 114 include spaced rails configured to receive the axle 28 of the carousels 20 thereon, with the annular rims 29, 29 of each carousel 20 securely retaining the carousel 20 thereon. The deck 106 may nominally be divided into two portions, a first portion 116 providing a space for retrieved carousels 20 (i.e. containing oysters ready to be graded or ready for market), and a second portion 118 providing a space for carousels 20 ready to be deployed (i.e. containing recently graded oysters).

As would be appreciated, if the number of carousels 20 on one of the portions 116, 118 was different to that on the other of the portions 116, 118, then the working platform 100 might become unbalanced in the water and its deck 106 would be on an angle (presenting a capsizing risk and potentially hazardous working environment). In order to address this, however, the working platform 100 may also include a pump or pumps (not shown) operable to pump water into reservoirs (not shown) into various portions at opposing ends of the hulls 102, 102. The pump may be operated such that water is taken in from the surrounding environment and used for ballast in order to provide an even weight distribution over the working platform 100. In this manner, the deck 106 of the working platform 100 can be maintained in a substantially level configuration, even in the event of one of the portions 116, 118 being full of oysters (and hence very heavy), whist the other portions 116, 118 is empty (or, alternatively, if one side of the working platform 110 is more heavily loaded than the other).

The working platform 100 may be moved in the water by using water jets (not shown) of the type routinely used in the art (propeller-driven barges may also be used, but are not preferred due to the possible damage which could be caused by a propeller and the significant propeller snag hazards). These jets can be positioned at various locations (either facing in different directions, or operable to face in different directions) over the working platform 100 and operated by the user.

In use, rotation of the carousels 20 could be stopped when the carousels were in an orientation whereby they are liftable off the float 16 (e.g. as shown in FIG. 6). Alternatively, the carousels 20 could be manually rotated into this orientation by the farmer on arrival at the farm. The farmer would then orientate the working platform 100 in line with the long lines 12, 12 and then drive over them, with the apparatuses 10, 10, etc. being received between hulls 102, 102, as can be seen in FIG. 9. The apparatuses 10, 10, etc. are spaced along the long lines 12, 12 such that a number of them (e.g. 2-5, depending on their separation) are located underneath the working platform 100 at any given time, and thus they also act to guide the working platform 100 along the long lines 12, 12, regardless of any cross current the working platform may be experiencing. The rounded ends of the float 16 can help to prevent the floats 16 (and hence the apparatus 10) from becoming jammed between the hulls 102, 102.

When an apparatus 10 is about centrally located underneath the access portal 112, a user would stop the barge 100 and attach a hook at the end of cable 111 to the upwardly orientated eyelets 38, 38 on the carousel 20. The hoist 110 would be engaged such that the carousel 20, and its attendant oyster-containing cages 18, is lifted off the float 16 and out of the water, through the access portal 112 and up into a lifted position (as shown in FIG. 10). In this lifted position, the gantry 108 can be used to align the axle 28 of the carousel 20 with the railings of appropriate storage rails 114 (e.g. in portion 116), and then lower the carousel 20 onto the railings. The so-located carousel can then be moved away from the portal 112 by rotating it on the rails, a task that is easily manually achievable. A carousel 20 from another portion of the working platform 100 (e.g. portion 118), which contains graded oysters ready for return to the water, can then be rolled into an appropriate position, lifted with the hoist 110, aligned with the portal 112 and lowered onto the (now empty) float 16 positioned underneath the portal 112.

This replacement operation is repeated until either all of the carousels 20 on the longlines 12, 12 have been replaced, or until all of the carousels 20 initially carried by the working platform 100 have been returned to the water. In this manner, in a single operation, oysters requiring grading are removed from the water and oysters that have been graded are returned to the water. The efficiency savings achievable by such a process are immediately apparent. During all of this operation, the pump(s) pumps water into or out from the respective portions of the hulls 102, 102 in order to keep the working platform 100 substantially level.

The working platform 100 would then be maneuvered to a land-based grading facility, where the carousels 20 containing oysters for grading or market can be unloaded and processed accordingly.

As described herein, the present invention provides improved oyster farming apparatus, especially adapted for farming intertidal oysters, as well as systems including a number of such apparatus on a longline and floating platforms for deploying and retrieving oyster cages (e.g. for grading). Embodiments of the present invention may have one or more of the advantages listed below over prior art oyster farming apparatus and systems.

The apparatus and systems of the present invention may be advantageous because:
intertidal oysters are grown in a controlled environment, with optimal conditions, which may help to accelerate their rate of growth and hence reduce the time taken to grow them to a marketable size.
much less manual effort is required to maintain the oysters (i.e. move them from above the water to under the water periodically), with the majority of such work being automatically performed.
the cages are modular in nature and thus typically smaller than many existing cages, but the carousels are capable of holding the same number (or more) of oysters in a more evenly distributed manner such that they all have ready access to nutrients in the water to thus enhance their growth (i.e. compared to existing cages where oysters can become bunched up at the bottom of relatively larger cages and thus not as readily able (if at all) to access nutrients).
the cages are easy to open in order to empty their contents into a grading machine, etc.
the cages may be formed of food grade plastic, which has no corrosion issues, is easily cleanable, has no food contamination issues, etc.
the floats hold the long lines apart by a precise and consistent distance along the entire length of the longlines.
the floats/apparatus can be positioned relatively close together because they won't twist with respect to the longlines.
the floats/apparatus can help to guide the floating platform along the longlines.
the carousels are easy to lift and lower off the floats, with tapered channels guiding the axle towards their respective operating positions. As such, operators do not need to be extremely precise when returning the oysters to the water.

The floating platforms of the present invention are advantageous because:
they can make it easier to work oysters more regularly, and by doing so reduce their growth time.
they can make it much easier to work oysters due to features such as: automated lifting/lowering of oyster cages (which can be bigger because of their modular nature), the slidability of the carousels along rails (which can be much easier/safer than manhandling cages), easy to transfer from the floating platform to the grading system (e.g. via complementary land-based rails), the users are working out of the water and hence can work in deeper water and do not have to lean out from the boat/barge (fewer WHS issues).
the buoyancy system operates to keep the floating platform level, despite potentially having a large off-centre mass.
it is possible to deploy graded oysters and collect ungraded oysters at the same time, resulting in a massive time saving.

It will be understood to persons skilled in the art of the invention that many modifications may be made without departing from the spirit and scope of the invention. All such modifications are intended to fall within the scope of the following claims.

It will be also understood that while the preceding description refers to specific sequences of method steps, pieces of apparatus and equipment and their configuration to perform such methods in relation to particular applications, such detail is provided for illustrative purposes only and is not intended to limit the scope of the present invention in any way.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-29. (canceled)

30. An apparatus for farming oysters, the apparatus comprising:
a float;
at least one oyster container configured to hold oysters and be carryable on the float; and
a driver operable to periodically move each of the at least one oyster container between an underwater position and an above water position.

31. The apparatus of claim 30, wherein a plurality of oyster containers are carryable on the float.

32. The apparatus of claim 30, wherein a plurality of oyster containers are provided in a rotatable cylinder.

33. The apparatus of claim 32, wherein the oyster containers are radially positioned in the rotatable cylinder.

34. The apparatus of claim 32, wherein the driver is operable to rotate the rotatable cylinder.

35. The apparatus of claim 30, wherein the driver is operable to move each of the at least one oyster container between the underwater and above water positions at a rate that mimics an intertidal environment.

36. The apparatus of claim 30, wherein the at least one oyster container is liftable off and lowerable onto the float.

37. The apparatus of claim 30, wherein the float comprises opposing side walls having channels which are configured to receive complementary portions of the at least one oyster container therein.

38. The apparatus of claim 30, wherein the float comprises attachments for attaching the float to one or more longlines.

39. The apparatus of claim 30, wherein each oyster container comprises a lid that is openable in order to access an interior of the oyster container.

40. A system for farming oysters, the system comprising:
a plurality of apparatus for farming oysters, each apparatus comprising:
a float;
at least one oyster container configured to hold oysters and be carryable on the float; and
a driver operable to periodically move each of the at least one oyster container between an underwater position and an above water position;
a longline, on which each of the plurality of apparatus for farming oysters is arranged; and
a parent float, arranged on the longline and comprising a motor operable to actuate the drivers of each of the plurality of apparatus for farming oysters.

41. The system of claim 40, further comprising an endless rope which is driveable by the motor in order to actuate the drivers of each of the plurality of apparatus for farming oysters.

42. The system of claim 40, wherein the system comprises one parent float for each ten apparatus for farming oysters.

43. A floating vessel for deploying and retrieving the at least one oyster container being carried on the float of the apparatus of claim 30, the floating vessel comprising:
spaced hulls configured to span the apparatus;
a deck; and
a centrally located portal, through which the at least one oyster container being carried on the float is accessible from the deck.

44. The floating vessel of claim 43, further comprising one or more of the following:
a lifter operable to lift the oyster containers off the float and on to the vessel;
a gantry operable to maneuver the oyster containers above the deck; and
racks upon which collected oyster containers are locatable.

45. The floating vessel of claim 44, wherein the floating vessel comprises a first portion for housing recently collected oyster containers and a second portion for housing oyster containers ready for deployment.

46. A carousel for use with the apparatus for farming oysters of claim 30, the carousel comprising an axis about which a plurality of oyster containers are radially arranged.

47. The carousel of claim 46, wherein the plurality of oyster containers are radially arranged whereby their weight is substantially evenly distributed about the axis.

48. The carousel of claim 46, wherein an end of the axis comprises a member that is coupleable to the driver such that operation of the driver causes the carousel to rotate about the axis.
